(19) United States
(12) Patent Application Publication
(10) Pub. No.: US 2026/0254129 A1
(43) Pub. Date: Aug. 27, 2026

(54) FOLDED SHEET DISH SUPPORT STRUCTURE

(71) Applicant: Paramium Technologies, Inc., Tucson, AZ (US)

(72) Inventors: Justin Hyatt, Tucson, AZ (US); Sean Benson, Hastings, NE (US)

(73) Assignee: Paramium Technologies, Inc., Tucson, AZ (US)

(21) Appl. No.: 19/546,347

(22) Filed: Feb. 21, 2026

Related U.S. Application Data
(60) Provisional application No. 63/761,609, filed on Feb. 21, 2025.

(51) Int. Cl. H01Q 19/12

(52) U.S. Cl. CPC H01Q 19/12

(57) ABSTRACT

The invention is an antenna support structure, reflecting antenna or both, substantially made from folded sheet material and method of making these. The resulting structure conforms to custom curved reflector surfaces without complicated assembly. Frame members cut out of flat sheets are cut, folded, bent, slotted or a combination thereof such that the resulting elements are efficiently and cheaply produced and assembled without the need for additional production, manipulation, fixturing devices or processes. Relief slits cut in folded flanges precisely align the flanges with corresponding slots. The parts slot together so that no fixturing is necessary to bond the structure together making assembly fast and easy and enabling shipping the structure flat and assembling it in the field. The geometry of mating flange and slots is unique for each member preventing parts from being assembled incorrectly. Folded edges strengthen and lightening holes decrease the mass of the members.

### BACKGROUND OF THE INVENTION

### Field of the Invention

The present invention relates to support structures for reflector dishes in antenna structures and methods of manufacturing such structures and dishes.

### Description of Related Art

Radio antennas on the ground have been used to communicate with satellites since the first artificial satellite entered orbit. These dishes have reflector panels that need to be supported so that their shape remains accurate even when wind and gravity loads are applied.

Also, to communicate with satellites in low earth orbit, some of these dishes need to track the satellites' positions in the sky. This requires that the dish maintains its shape while accelerating and changing its orientation and that the dish structure be lightweight.

Antennas with dish reflectors gather signals over a larger area and focus it on a smaller receiver. These reflector shapes are typically paraboloids, hyperboloids or other shapes optimized for focusing the radio signals. Some applications require off-axis antenna shapes that are not radially symmetrical. The off-axis shape allows the entire reflecting surface of the antenna to reflect the satellite signal without the elements of the receiver blocking the signal.

The high rigidity and low weight requirements combined with the unique curved shapes make manufacturing these dish support structures complicated. Traditionally, large dish support structures are made using space frames or three-dimensional truss structures. These use frame members of many different specific lengths. It also means that joints or nodes connect members at varied, non-standard angles. This makes manufacturing these nodes and members expensive and assembly of the different members at different angles complicated and time-consuming.

Radio communication antenna system 2 or other dish structures 4 have been designed and built using components including space frame 6 or truss structure 8 elements (FIG. 1). These space frames 6 or truss structures 8 have required joining structural members at nodes 10 with complex angles and often multiple structural pieces (e.g., space frame 6 or truss structures 8) connected at a single node 10. These frame and truss pieces are difficult to make and assemble, particularly when connecting at nodes and more particularly when connecting at nodes with complex angles. Further, because some of these pieces are interchangeable, it is possible to connect certain pieces in undesirable configurations. Thus, the problem of making frame and truss pieces easier to make and assemble and also preventing mis-assembly of pieces are problems in need of a solution.

### SUMMARY OF THE INVENTION

The present invention in various embodiments is an antenna support structure, reflecting antenna or both and method of making these components. The support structure, sometimes referred to as a backup structure for radio reflectors, is substantially made from elements made of folded sheet material, as for example, sheet metal, plastic or fiberglass. This concept allows for creating a structure that conforms to custom curved reflector surfaces without complicated assembly.

Frame members cut out of flat sheets are cut, folded, bent, slotted or a combination thereof such that the resulting elements are efficiently and cheaply produced and assembled without the need for additional production, manipulation, fixturing devices or processes. Relief slits cut in folded flanges precisely align flanges with corresponding slots where the flanges and slots may be on either the trusses, reflector panels or combinations of both. The flanges mate with the slots so that no fixturing is necessary to bond the structures connected to either the flanges or slots. This makes assembly fast and easy and enables shipping the structure flat and assembling it in the field. The geometry of mating flange and slots is unique for each member preventing parts from being assembled incorrectly. Folded edges strengthen and lightening holes decrease the mass of the members.

Modern computer numerically controlled CNC machines can quickly and inexpensively cut precision shapes out of flat sheets. Frame members can be cut out of flat sheets inexpensively using a water jet, plasma, or laser cutter, for example. These sheets of material may then be cut, folded, bent, slotted, or a combination thereof such that the sheets of material is efficiently and cheaply produced and assembled without the need for additional production, manipulation, fixturing devices or processes. Relief slits can be cut in the parts so that folded flanges precisely align with almost any angle to align with the reflector mounts. The parts can slot together so that no fixturing is necessary to bond the structure together. This makes assembly fast and easy and enables shipping the structure flat and assembling it in the field.

In addition, flanges can be folded on the edges to strengthen the members and lightening holes can be added to decrease the mass of the members. Also, the geometry of the mating joints can be unique for each member without increasing the part cost. This prevents parts from being assembled incorrectly according to the concept of Poka-yoke which means that there is only one possible way to assemble parts.

One of the unique and inventive technical features of the present invention is the implementation of bent, cut and folded sheets of material configured to interlock to form a reflector dish support structure. Without wishing to limit the invention to any theory or mechanism, it is believed that the technical features of the present invention advantageously provide for easy-to-assemble and low-cost support structures that do not require fixturing processes to assemble the support structure. None of the presently known prior references or works have the unique inventive technical feature of the present invention.

Another aspect of embodiments of the invention is the application of the principle of Poke-yoke so that elements of the invention are prevented from being incorrectly attached to or positioned, located or oriented with respect to other elements of the invention.

In view of the foregoing, this invention facilitates the mass production of radio dish antennas and support structures. Hence, the invention increases the speed of manufacture and assembly and decreases the cost.

It is an objective of some aspects of the present invention to provide support structures for reflecting antennas or the reflecting surface themselves that are each substantially made of sheets of material.

It is an objective of other aspects of the present invention to provide support structures for reflecting antennas or the reflecting surface themselves that increase the ease of construction, assembly or both.

It is a further objective of some aspects of the present invention to provide support structures for reflecting antennas or the reflecting surface themselves that prevent the connection of parts or elements into incorrect position or orientation.

Some objects of the present invention will be present in some embodiments and other objects in other embodiments. It is not required that all objects be present in all embodiments. Further, embodiments of the present invention can be freely combined with each other if they are not mutually exclusive.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

The features and advantages of the present invention will become apparent from consideration of the following detailed description presented in connection with the accompanying drawings. The invention will be described hereafter in detail with particular reference to the drawings. Throughout this description, like elements, in whatever embodiment described, refer to common elements wherever referred to and referenced by the same reference number. The characteristics, attributes, functions, interrelations ascribed to a particular element in one location apply to that element when referred to by the same reference number in another location unless specifically stated otherwise. In addition, the exact dimensions, proportions and function of many aspects of the present invention, if not specifically mentioned, will be within the skill of the art after the following description has been read and understood. All Figures are drawn for ease of explanation of the basic teachings of the present invention only and are not intended to limit the scope of the invention.

FIG. 1 is a perspective view of a prior art reflector dish and support structure.

FIG. 2 is a perspective view of a reflector antenna with a support structure in accordance with embodiments of the invention.

FIG. 3 is a side view of the outline of an embodiment of a unibody truss cut out of a flat sheet of material before the flat sheet is folded.

FIG. 4 is a perspective view of an embodiment of the unibody truss after it is folded from the flat sheet of FIG. 3.

FIG. 5 is a perspective view of an alternate configuration of an embodiment of a unibody truss.

FIG. 6 is a perspective view of yet another configuration of an embodiment of a unibody truss with folded edges.

FIG. 7 is a perspective view of an embodiment of a truss with holes cut in the web to show a visual design including text and a graphic.

FIG. 8 is a perspective view of an embodiment of multiple trusses joined together.

FIG. 9 is a perspective view of a portion of the truss from FIG. 4 with a slot formed in in the web that does not extend to the edges of the truss.

FIG. 10 is a perspective view of a system of multiple trusses, including the truss from FIG. 9, where a second truss is inserted into a slot in the web of the truss from FIG. 9.

FIG. 11 is two perspective views of a truss formed as a tube or as a sheet of material rolled or folded so that its cross section has a closed shape.

FIG. 12 is a side view of a truss showing the bend axis and plane of a mounting flange that is parallel to a predetermined plane that is optimal for the mounting flange.

FIG. 13 is a perspective view of a truss showing the bend axis of a mounting flange that is bent along its bend axis at a predetermined angle with respect to the web of the member.

FIG. 14 is a perspective view of a truss and a reflector panel joined together.

FIG. 15 is an exploded view of embodiments of mounting flanges and a truss to which they are attached.

FIG. 16 is a perspective view of mounting flanges and truss of FIG. 15 where the mounting flanges are coupled to the truss.

FIG. 17 is a perspective view of the truss of FIG. 4 with mating and non-mating configurations of a reflector panel.

FIG. 18 is perspective view of a fastener connection between a truss and reflector panel according to embodiments of the invention.

FIG. 19 is a perspective view of multiple trusses coupled using fasteners.

FIG. 20 is a perspective view of a reflector panel coupled to a truss by flanges on the truss mating with slots in the reflector panel.

FIG. 21 is a perspective view of a reflector panel coupled to a truss by flanges on the reflector panel mating with slots in the truss.

### DETAILED DESCRIPTION OF THE INVENTION

The present invention relates to a support structure 12 for a radio communication antenna system 2 or other dish structure 4. Referring now to FIG. 2, the present invention features a support structure 12 made from at least one truss 14 that is connected to at least one reflector panel 16.

The connection between the truss 14 and the reflector panel 16 in a preferred embodiment is through flanges 18 and slots 20. Flanges 18 and slots 20 mate together to affix the flange 18 and slot 20 together in a firm locked and fixed position through a tab-and-slot locking joint. Flanges 18 and slots 20 may be located on either the truss 14 or reflector panel 16 in whatever arrangement is most expeditious as provided by the desired geometry of the truss 14 and reflector panel 16 where the two come into contact with each other. An important aspect of the invention is that the truss 14 is formed with characteristics, as will be described herein, that allow it to affix with the reflector panels 16 of the antenna system 2 in specific positions and orientations.

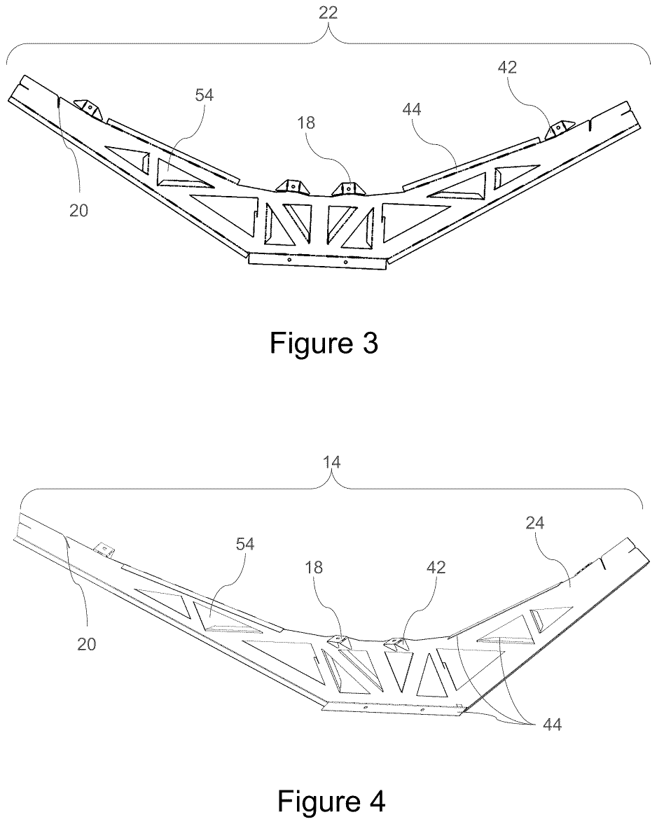

Truss 14 in a preferred embodiment of the invention is unibody, meaning made from one or more sheets of material in a single piece. In this embodiment, the truss 14 is formed by folding, bending, pressing or forming the truss 14 as a single unitary piece as is well understood in the art to form strong, lightweight structures. A key feature of the truss 14 in this embodiment is that the truss 14 is formed from an initially flat sheet of material (FIG. 3). In FIG. 3, the dotted lines indicate where flanges 18 are to be bent or folded as will be explained hereafter.

The primary functions of truss 14 are to provide a support for the positioning of the antenna system 2 and to connect the antenna system 2 to a mount. Since antenna system 2 in one embodiment of the invention is made of reflector panels 16, other functions of truss 14 are to position respective reflector panels 16 with respect to the truss 14 and, in some embodiments of the invention described herein, to ensure that only intended elements (e.g., reflector panels 16) be attached to the truss 14. These functions of truss 14 are not mutually required. For example, it is not required in all embodiments of the invention that the truss 14 position elements such as flanges 18 to be attached to the truss 14 in positions that prohibit some reflector panels 16 from connecting to some flanges 18 as will be explained hereafter.

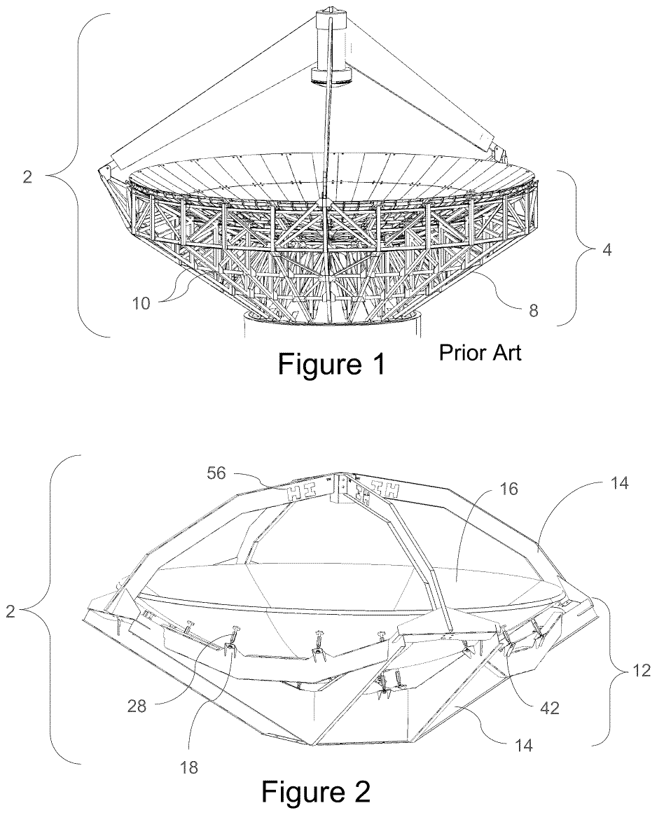

Historically, support structures 12 (FIG. 1) were made from pieces of material such as tubes or plate pieces that are affixed, as for example by welding, gluing or through the use of screws or nuts and bolts, often involving connector pieces such as nodes 10 or connecting plates to produce the desired elements of the support structures 12 including the shape of any truss structure 8. One aspect of the present invention is that in practice, it has been found to be much easier to cut a flat sheet of material, as for example by laser, plasma or water jet cutting, to a desired shape and then bend that cut shape, as by folding, bending or pressing, into the desired shape for the truss 14 than it has been to take individual pieces of material and affix them as been the historical practice.

As mentioned, in a preferred embodiment of the present invention, truss 14 is formed from a single piece of flat material 22 (FIG. 3) that is cut and then formed into the desired shape of the truss 14. The flat material 22 may be a metal such as steel or aluminum, plastic, fiberglass, carbon composite or any other material that is easily formed initially flat, that can then be cut and folded into the desired shape. Alternately, truss 14 can be molded, cast or formed into the desired shape. A desirable aspect of truss 14 is that it is relatively easy to manufacture.

Modern Computer Numerically Controlled (“CNC”) machines can quickly and inexpensively cut precision shapes out of flat sheets such as flat material 22. Pieces of support structure 12 can be cut out of flat material 22 inexpensively using a water jet, plasma or laser cutter, for example as is well understood in the art. The cutting of the flat material 22 not only determines the outer shape of the cut piece but CNC machining also may form cuts, holes or slots that help form desired elements or features as will be described hereafter. Cutting the shape, holes or slots of the flat material 22 while flat using CNC machines is a distinct advantage in production speed, cost and precision compared with forming such shapes, holes or slots after the fact and by conventional methods.

A preferred embodiment of the invention uses trusses 14, each made from a single sheet of material, to form a so-called unibody truss 14. However, in alternate embodiments of the invention, trusses 14 are made by stacking several layers of flat material 22 into a laminate, cutting the laminate and then bending or folding the laminate to form the truss 14. This laminate structure allows reinforcing layers to improve characteristics of the truss such as reducing weight, increasing strength or increasing flexibility compared to some unibody trusses 14. A further alternate embodiment of the invention involves taking several pieces of material, whether flat material 22 or not, and connecting them as by welding, gluing or through the use of screws or nuts and bolts or connector pieces such as nodes or connecting plates to produce the desired elements of the support structures 12 including the shape of any truss 14. The truss 14, however formed, has a web 24 that is the main body of the truss 14.

In another preferred unibody embodiment of truss 14, as well as the alternate embodiments of truss 14 where truss 14 is not a unibody construction as described below, truss 14 is a tube 26 or a sheet of flat material 22 rolled or folded so that its cross section has a closed shape such as for example a polygon or a circle (FIG. 11). Even though such closed shapes are made of rolled or folded material, which may be relatively thin compared to the cross-section of the closed shape, such rolled or folded closed shapes have considerable strength and rigidity.

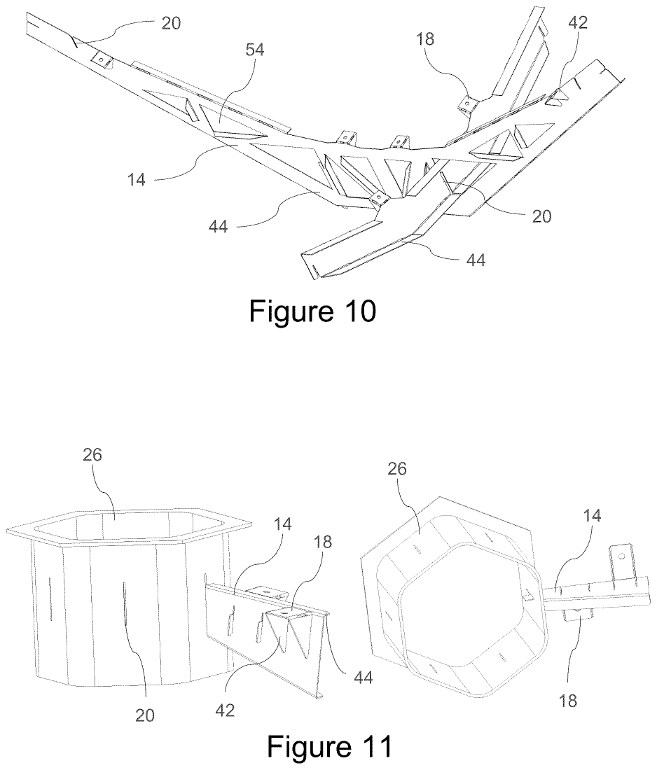

Truss 14, however made as described herein, has connector elements such as flanges 18 and slots 20 that allow truss 14 to firmly and securely connect to either reflector panels 16 or other trusses 14. Flanges 18 and slots 20 are configured to mate with and establish a relative configuration, orientation and position between each other when flange 18 is mated with the slot 20. In some embodiments where only one truss 14 is present (FIGS. 4, 5 and 6) or two or more trusses 14 are connected together (FIGS. 8 and 10) as will be explained hereafter, a first truss 14 includes a slot 20.

In one embodiment of the invention, flanges 18 and slots 20 mate with each other in a tab-and-slot locking joint to produce a firm and secure connection (FIG. 8). In an alternate embodiment of the invention, two flanges 18 are positioned in contact with each other and fastened together by hardware 28 such as screws or nuts and bolts. (FIG. 17) In this embodiment of the invention, flanges 18 are located on both the truss 14 and reflector panel 16.

In embodiments of the invention with multiple trusses 14, slot 20 may be configured to mate with the flange 18 of a second truss 14 such that the slot 20 limits and establishes a relative position of the first truss 14 and the second truss 14 to a predetermined mating configuration based on the geometry of the flange 18, slot 20 and the trusses 14. In some embodiments where individual trusses 14 are combined to form a single truss 14, the first truss 14 is coupled to the second truss 14 by welding, one or more mechanical fasteners, glue or other adhesives or a combination thereof.

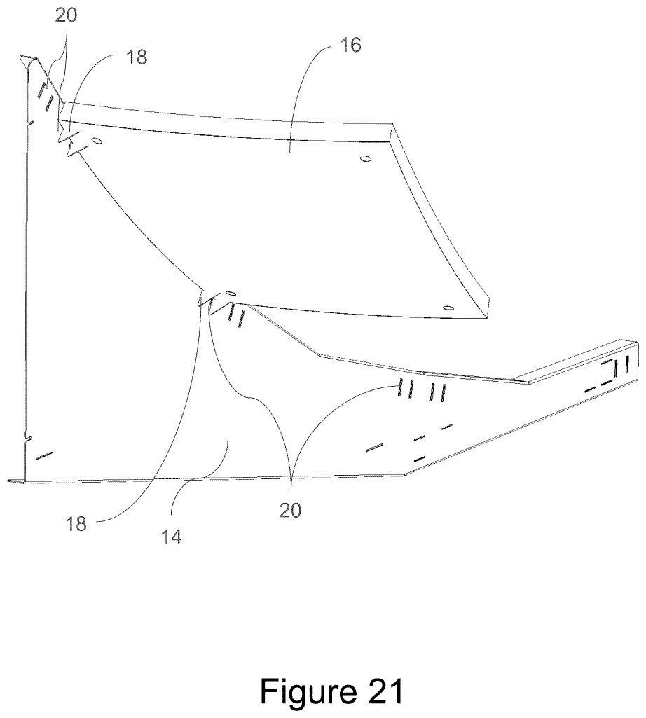

In embodiments of the invention where a truss 14, whether as the only truss 14 or part of several trusses 14 joined together, truss 14 has a slot 20 and that slot 20 is used to connect the truss 14 or trusses 14 to one or more reflector panels 16. In these embodiments, a flange 18 on a reflector panel 16 is intended to connect directly to the slot 20 cut in the truss 14 or trusses 14 to receive flange 18 so that the truss 14 and relative reflector panel 16 are established in a specific orientation and position. Here, slot 20 is preferably also cut in the reflector panel 16 by CNC machining or forming while the reflector panel 16 is flat to simplify the manufacturing process. The mounting flange 18 on the reflector panel 16 is oriented such that the mounting flange 18 may directly connect to the desired slot 20 on the truss 14 or trusses 14 at a desired position and orientation specified by the geometry of the flange 18, slot 20 and the truss 14 (FIG. 21).

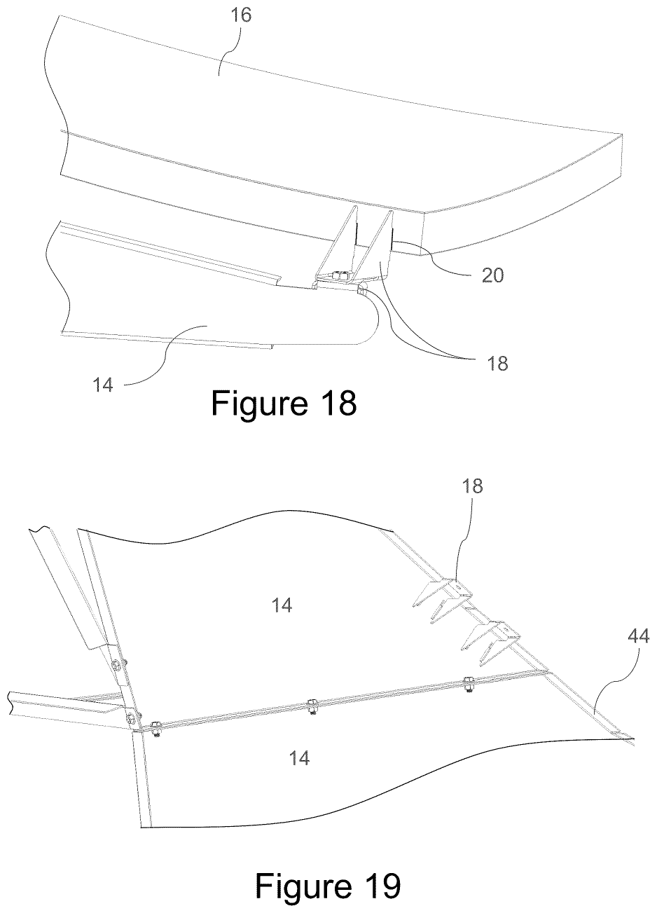

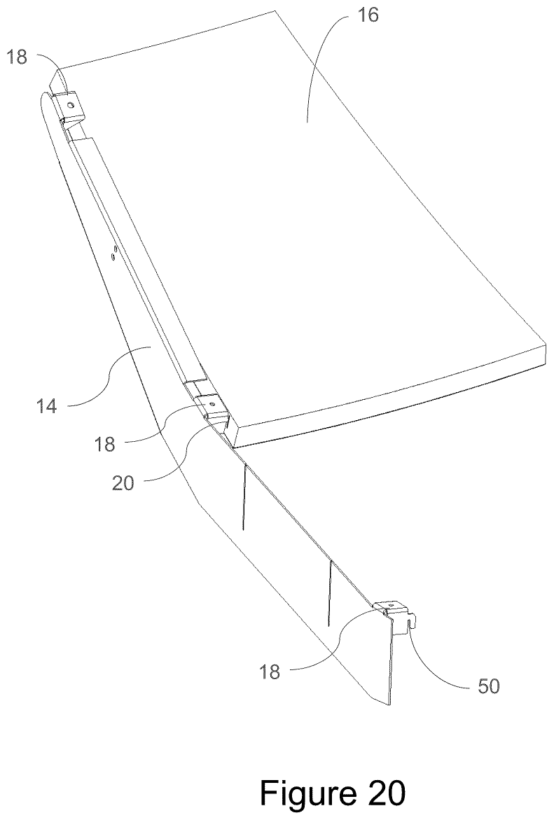

Embodiments of the invention have the flange 18 on truss 14 connecting directly to a reflector panel 16. In these embodiments (FIG. 18), the reflector panel 16 has a slot 20 cut in it to receive flange 18 so that the truss 14 and relative reflector panel 16 are established in a specific orientation and mated together. Here, slot 20 is preferably also cut in the reflector panel 16 by CNC machining or forming while the reflector panel 16 is flat to simplify the manufacturing process. Again, the mounting flange 18 on a truss 14 is oriented such that the mounting flange 18 is configured to connect directly to a reflector panel 16 of the radio reflector antenna system 2 and the dish structure 4 at a desired position and orientation specified by the geometry of the flange 18, slot 20 and the truss 14 (FIG. 20).

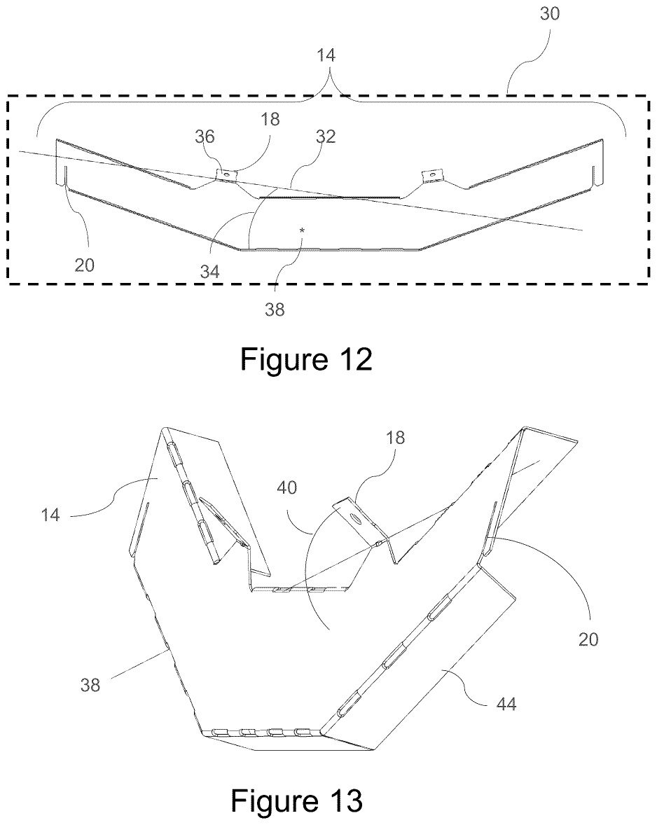

Flanges 18, whether on trusses or reflector panels 16, may be formed by simply bending portions of the material of flat material 22 to a desired orientation with respect to the plane of the flat material 22, the truss 14 or reflector panel 16 as will be explained hereafter particularly with reference to FIGS. 12 and 13. Flange 18 is preferably made by bending a portion of the truss 14 by a desired angle relative to the first plane 30 that aligns with the web 24 of truss 14 as shown in FIG. 12. First plane 30 here means the plane through with the web 24 of the elongated truss 14 passes.

Flange 18 is bent around a first bending axis 32. First bending axis 32 is oriented at any desired angle to establish the desired position of the flange 18 after it is bent around first bending axis 32 according to the design of the support structure 12. The first bending axis 32 of the mounting flange 18 may be in the first plane 30 of the web 24 of truss 14 oriented at a first bend angle 34 parallel to a predetermined second plane 36 for the mounting flange 18 and the second bend angle 40 of the mounting flange 18 is such that the mounting flange 18 is substantially parallel to the predetermined second plane 36 for mounting the reflector 14. The first bending axis 32 can be rotated in the plane 30 of the web 24 around a second axis 38 that is normal to the plane 30 of the web 24 and therefore perpendicular to the first bending axis 32, these two orthogonal degrees of freedom allow the face of the mounting flange 18 to be oriented at virtually any angle (FIGS. 12 and 13).

In a preferred embodiment of the invention, first bending axis 32 is located at an angle, the first bend angle 34, that is parallel to a predetermined second plane 36. Second plane 36 is the plane that includes flange 18 after flange 18 has been bent around first bending axis 32 and establishes the orientation of flange 18 to the truss 14 to which it is attached. In some embodiments of the invention, first plane 30 and second plane 36 may be coextensive or parallel. In other embodiments of the invention, first plane 30 and second plane 36 may not be either coextensive or parallel.

The angle through which flange 18 must be bent to align flange 18 as coextensive or substantially parallel to second plane 36 is called the first bend angle 34. Since in many embodiments of truss 14, truss 14 is substantially planar within first plane 30 (i.e., the web 24 aligns with first plane 30), bend first bend angle 34 in these embodiments is the angle between first plane 30 and second plane 36. In practice, bend first bend angle 34 may vary from only a few degrees to exceeding 90 degrees approaching 180 degrees. The key factor to determining both the first bending axis 32 and the bend first bend angle 34 is that each much be chosen so that the resulting flange 18 after being bent is oriented to connect the flange 18, and thus its corresponding truss 14, to either another truss 14 or a section of the radio reflector antenna system 2 (e.g., a reflector panel 16) at exactly the desired location and configuration. The term “substantially parallel” is defined herein as a first angle relative to a plane oriented at a second angle such that the first angle is within at most 5 degrees of the second angle.

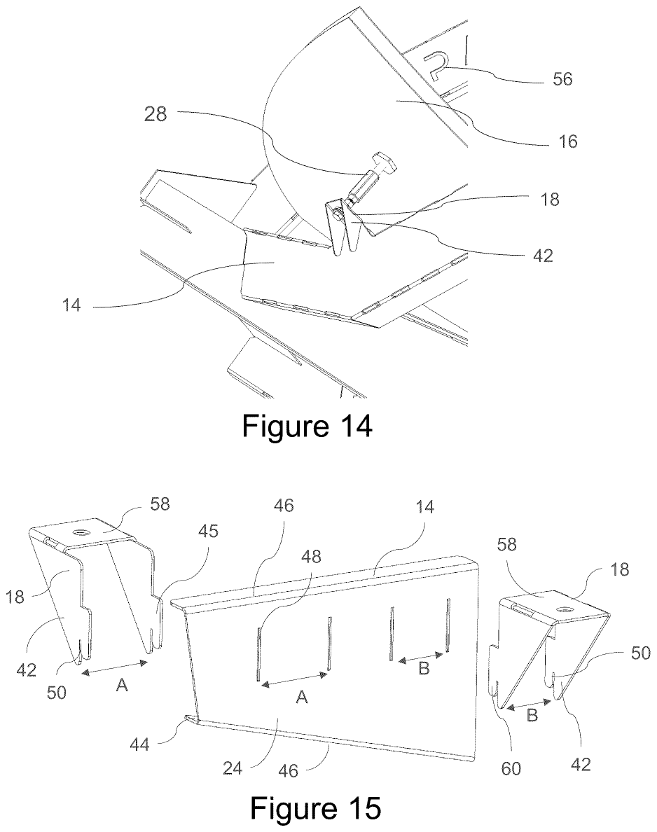

Once formed, flanges 18 in truss 14 may, for example, then be joined to slot 20 in the reflector panels 16 (FIG. 20) or vice versa (i.e., flanges 18 in reflector panels 16 may, for example, then be joined to 38 in the truss 14) to connect a truss 14 to a corresponding reflector panel 16 (FIG. 21). In practice, the mounting flanges 18 on the reflector panels 16 are often substantially tangential to the curve of the reflector panel 16 near the mounting location (FIG. 14). This is because this location is often roughly equidistant from the edges of the reflector panel 16 so that and stresses put on the flange 18 by, for example, the weight of the antenna system 2 or wind load on the antenna system 2, are spread over the reflector panel 16 thereby reducing the likelihood or fatigue and ultimately failure of either the flange 18 or the reflector panel 16.

Because these flanges 18 are cut into the reflector panels 16 when the reflector panels 16 were flat, the present invention allows fabricating these mounting flanges 18 at a wide range of angles while maintaining simple, rapid manufacturing. This greatly simplifies the formation of reflector panels 16 as opposed to having to attach flanges similar to flanges 18 to reflector panels 16 later by methods such as welding, adhesives, screws and nuts and bolts which are manually intensive and require accurate positioning. Creating the flanges 18 at a time when the reflector panel 16 is flat and therefore easy to position is an important aspect of embodiments of the invention.

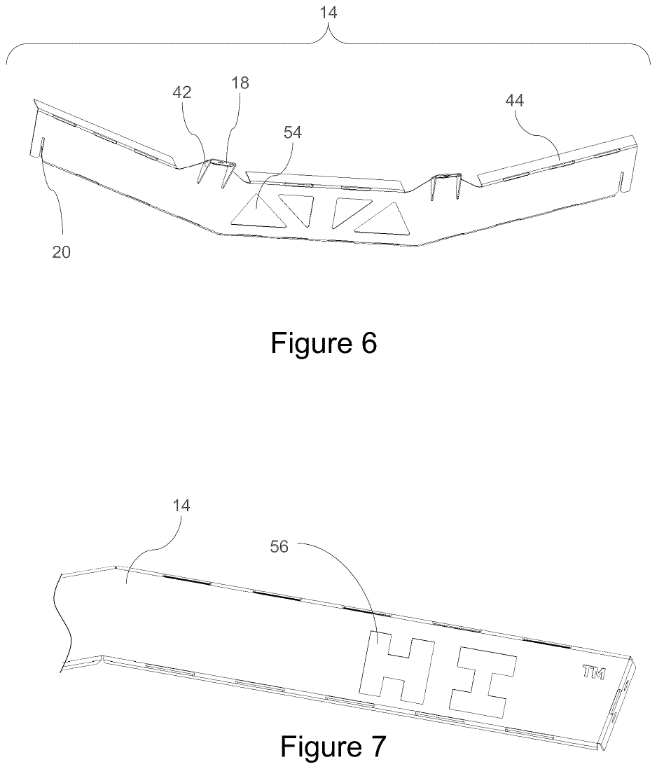

In some embodiments (FIGS. 6, 9, 11, 15 and 16), the mounting flange 18 further comprises at least one tab 42 that is bent at a particular angle with respect to the mounting flange 18 such that the shape of the tab 42 limits the bend first bend angle 34 of the mounting flange 18. As a result, the mounting flange 18 is limited to and fixed in a predetermined orientation with respect to the truss 14 if it is on truss 14 or the reflector panel 16 if it is on a reflector panel 16. By establishing the position of the connecting portion of mounting flange 18 and by contacting the truss 14 or reflector panel 16, respectively, in compression, the tab 42 is prevented from moving even under great load. This adds structural strength to the flange 18. In embodiments using a tab 42, the tabs 42 as well as flange 18 are preferably cut from the flat material 22 of flat material 22 by CNC machining at the time that flat material 22 is cut.

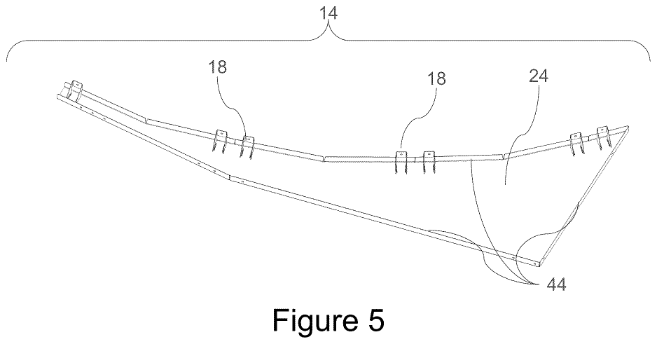

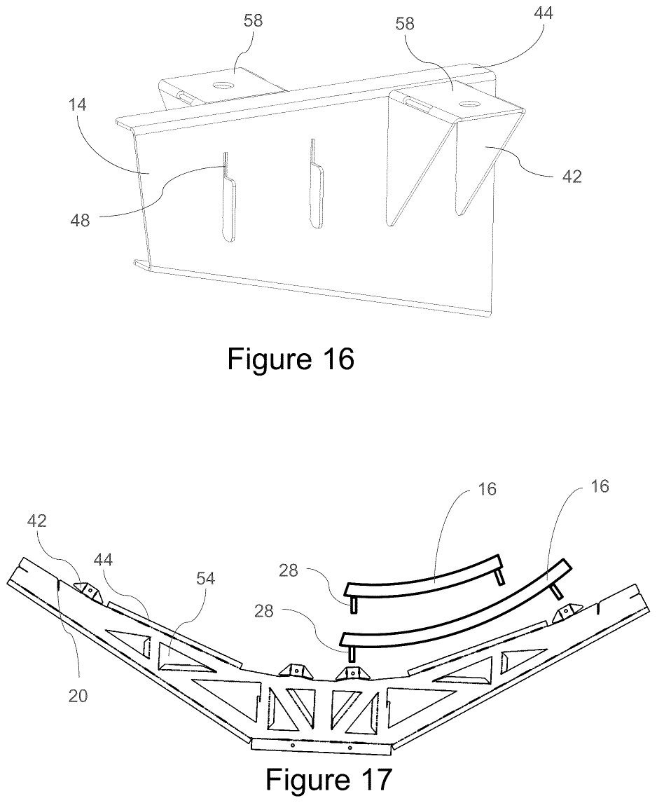

As can be seen in FIGS. 5, 6, 9, 11, 15 and 16, the tab 42 of the mounting flange 18 is coupled to at least one other portion of the truss 14, for example by physical compression contact, to increase rigidity and strength of the mounting flange 18. In some embodiments of the invention such as those shown in FIGS. 15 and 16, the mounting flange 18 is a separate component that is then coupled to the truss 14. In this embodiment of flange 18, flange 18 preferably also has tabs 42 that function as described above to increase the structural strength of flange 18 through structural stiffening through geometry.

In further embodiments of the invention, individually formed trusses 14 are combined to form the support structure 12. In these embodiments (FIGS. 8 and 10), a first truss 14 is coupled to at least a second truss 14 to form an interlocking support structure 12. In configurations of these embodiments, each truss 14 is made from one or more sheets of flat material 22 as described herein. A first truss 14 of the plurality of interlocking trusses 14 is coupled to at least a second truss 14 of the plurality of interlocking trusses 14 (FIG. 8). The first truss 14 may include a flange 18 or slot 20 configured to mate with the slot 20 or flange 18, respectively, of a second truss 14 such that relationship between the flange 18 and the slot 20 establishes and limits a relative position of the first truss 14 and the second truss 14 to a predetermined mating configuration. In other words, once the flange 18 of first truss 14 is mated to the slot 20 of the second truss 14, the geometric relationship between the two trusses 14 is firmly established. This mating is preferably through a tab-and-slot locking joint.

In these embodiments of multiple trusses 14 combined together, there may be as many trusses 14 joined together as desired. Where multiple trusses 14 are used in a support structure 12, each truss 14 may, but is not required to be, unitary and may, but is not required to include, closed or open structures. Further some trusses 14 may be of one type as disclosed herein and other trusses 14 of another type. Such “combined” trusses 14 may be formed and connected as desired in the configurations needed to match the geometry of the antenna system 2 and the corresponding reflector panels 16 to which they are connected.

In the embodiments of the invention shown in FIG. 11, a first truss 14 of the plurality of interlocking trusses 14 comprises a sheet of material rolled, folded, or a combination thereof such that a cross-section of the truss 14 comprises a closed shape such as a polygonal shape. As mentioned above, even though such closed shapes are made of rolled or folded material, which may be relatively thin compared to the cross-section of the closed shape, such rolled or folded closed shapes have considerable strength and rigidity.

Support structures 12 may be made entirely of a single unitary piece truss 14 or multiple trusses 14 either standing on their own or joined together. Where multiple trusses 14 are used, each truss 14 may be made of a single unitary truss or made from several pieces or a combination of these. Again, in these alternate embodiments of the invention, an important aspect of the invention is that the truss 14, however formed, is formed with characteristics, as will be described hereafter, that allow it to affix with the reflector panels 16 of the antenna system 2.

The geometric relationship between a truss 14 when connected to or interlocking with either another truss 14 or a reflector panel 16 depends ultimately on the relationship needed to attach one or more trusses 14 to the antenna system 2 through its reflector panels 16 to provide the desired support for the antenna system 2. If the shape of the antenna system 2 changes, for example in size, parabolic shape or if the dish is an offset dish, the necessary geometric configuration between the trusses 14 must necessarily change to match the characteristics of the antenna system 2. Where a single truss 14 is used to connect to the antenna system 2, the physical characteristics of the truss 14 must match the characteristics of the antenna system 2 in order to connect to and provide support for the antenna system 2.

In some embodiments (FIGS. 4, 5 and 13), truss 14 in whatever form it takes comprises at least one folded edge 44 configured to provide increased stiffness to the truss 14. In other words, folded edge 44 acts as a stiffening flange for the truss 14. For example, as can be seen in FIG. 4, folded edges 44 are formed by taking a portion of the flat material 22 that formed truss 14 and bending the portion at a considerable angle with respect to the other planar material of truss 14. In the embodiment shown in FIG. 13, the folded edges 32 are bent at not as much of an angle with respect to the other planar material of truss 14 as is the case with the embodiment of FIG. 4.

Folded edges 32 may be applied to either or both of a truss 14 or reflector panel 16. The use of folded edges 32 to stiffen material is generally referred to as “structural stiffening through geometry” and increases the “bending stiffness” (also called “flexural stiffness”) to improve the structural rigidity of the truss 14 or reflector panel 16 to which they are applied.

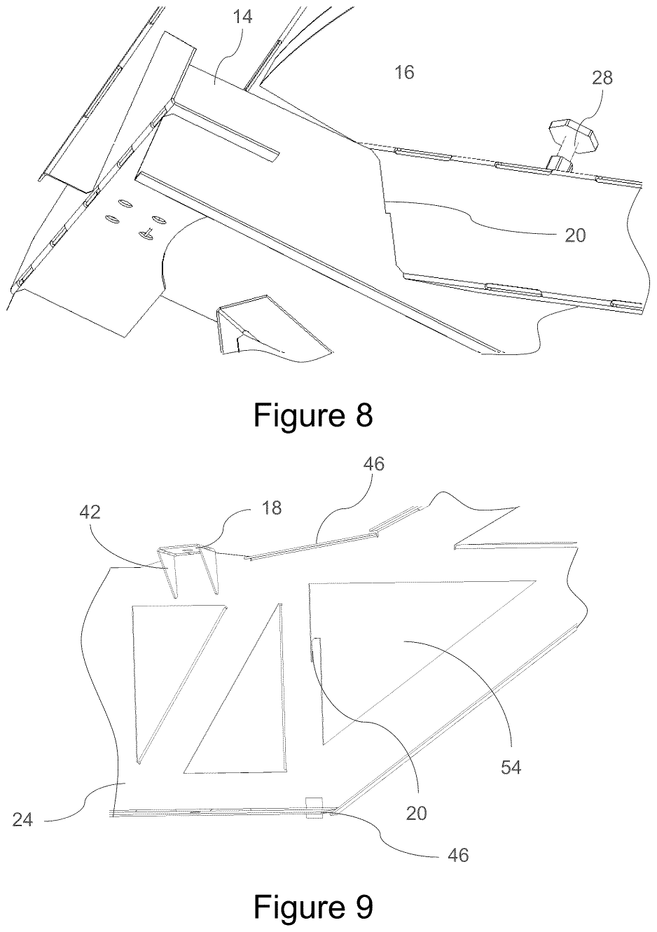

In the embodiments of FIG. 9, truss 14 has slot 20 cut in the web 24 of the truss 14 so that the slot 20 does not extend to the outer edges 46 of the truss 14. This allows truss 14 to be coupled to either another truss 14 (FIG. 10) or a reflector panel 16 through a flange 18 and the slot 20 without slots 20 cutting through the folded edges 44 of the truss 14. This preserves the structural integrity of the truss 14.

In the embodiments shown in FIGS. 15 and 16, truss 14 includes a mating slot 48 cut in a center web 24 of the truss 14 such that the mating slot 48 does not extend to any edges (e.g., outer edges 46) of the truss 14. Slot 48 receives a flange 18 from either another truss 14 or reflector panel 16. The function of slot 48 is to position either the truss 14 or reflector panel 16 in specific, defined positions and orientations or to connect two trusses 14, also in specific, defined positions and orientations. Having the mating slot 48 in this configuration allows the flange 18 to mate with mating slot 48 without compromising the integrity of the truss 14. Flange 18 may mate with slot 48 by dimensional interference (i.e., friction) or flange 18 may have hardware (e.g., screws, nuts and bolts) attached to it after it has passed through slot 48 to prevent flange 18 from being retracted through slot 48 or it may be fixed, for example, by adhesive or welding.

Alternately, as shown in FIG. 15, slot 48 may receive and position a flange 18 that also has at least one tab 42 and where each tab has a slit 50 that extends to the edge 52 of the tab 42. In this configuration, tabs 42 mates with the slit 50 when flange 18 is moved downward so that the slit 50 mates with the mating slot 48 in a tab-and-slot locking joint.

Also, in various embodiments of the invention, one or multiple holes 54 are cut in a truss 14 (FIGS. 4, 5 and 6). Holes 54 serve several functions. For example, holes 54 decrease the weight of the structure or decrease the wind drag of the truss 14 or both. In various embodiments of the invention, one or multiple holes 54 provide access to other antenna components once the system 12 is assembled (FIG. 6). Holes 54 may provide any combination of benefits listed above. In various embodiments of the invention (FIG. 7), one or multiple holes 56 show or create a visual design, such as for example, text or a graphic such as instructions, warnings, compass orientation or the name of the manufacturer. This may be done for practical, risk reduction, ease of use, aesthetic or marketing purposes. It may also be used for identifying parts during fabrication, storage, shipping, and assembly.

In various embodiments of the invention (FIGS. 9, 10, 11 and 14), trusses 14 have one or more mounting flanges 18 to which reflector panels 16 are fastened. In a preferred embodiment of the invention, reflector panels 16 are attached to a support structure 12 with hardware 28 (FIGS. 2, 8, 14 and 17) that allows fine adjustment of the position and orientation of the reflector panel 16 with respect to the mounting flanges 18. Examples of hardware 28 include, but are not limited to, nuts and bolts including with washers or spacers or turnbuckles to create a desired positioning and orientation with respect to the truss 14 that is attaches to.

In embodiments of the invention shown in FIGS. 15 and 16, the mounting flanges 18 are formed as a separate components from truss 14 that is then coupled to truss 14. Flange 18 in this embodiment includes tabs 42 and slits 50 formed in the tabs 42. Slits 50 are formed at particular locations and angles in tab 42 to correspond to the desired corresponding location and orientation of slots 48 on the truss 14 so that flange 18 is positioned in a specific location and orientation and locked in place via a tab-and-slot locking joint. This allows truss 14 and reflector panel 16 to be mated together in the desired configuration, position and orientation.

In this embodiment, flange 18 has at least one tab 42 and also includes a mounting surface 58. Although flange 18 in this embodiment has at least one tab 42, the preferred number of tabs 42 is two. The function of mounting surface 58 is to provide a flat surface against which a reflector panel 16 can be placed so that the mounting surface 58 helps correctly position reflector panel 16 with respect to the flange 18 and thus truss 14.

As mentioned, in the embodiment of FIGS. 15 and 16, flange 18 is formed as a separate component from truss 14. In the preferred embodiment of flange 18 in this configuration, flange 18 is cut from a single piece of flat material 22 and then the tabs 42 are formed by folding or bending the tabs 42 to provide structural support for the mounting surface 58. In this embodiment, the tabs 42 are cut to have a slit 50 that forms a separate piece 60 of tab 42 attached to but separated from the main body of the tab 42 by slit 50. The separate pieces 60 of a flange 18 are passed through slots 48 and then flange 18 is moved downward so that each slit 50 engages with slot 48 in a tab-and-slot locking joint. In this way, when flange 18 is brought into mating contact with a slot 48, slot 48 conformally mates with the slit 50 to lock the flange 18 into a tab-and-slot locking joint.

This embodiment of flange 18 preferably has flange 18 having its tabs 42 extend through and mate with slots 48. However, a variation on this embodiment has tabs 42 coupled to the truss 14 at the location of slots 48 by welding or adhesive or other connections that firmly position and hold the flange 18 in a desired configuration, position and orientation with respect to the truss 14.

In a variation of the embodiments of the invention shown in FIGS. 15 and 16, each flange 18 has a unique shape, for example but not limited to, the distance in spacing between tabs 42. As shown in FIG. 15 the distance between tabs 42 in a flange 18 is “A” for one flange 18 and “B” for another flange 18. Creating various flanges 18 with varying spacing such as A and B follows the principle of Poka-yoke, where the design of a part prevents the manufacturer from connecting or orienting components incorrectly as will be described hereafter.

In this variation, these differently spaced tabs 42 are coupled to corresponding slots 48 on a portion of the truss 14 such as on web 24. Respective slots 48 are separated by distance “A” for the flange 18 with its tabs separated by a distance “A” while other slots 48 are separated by distance “B” for the flange 18 with its tabs separated by a distance “B.” The mating geometry of different flanges 18 and their respective slots 48 prevents installation mistakes.

As shown in FIG. 15, the spacing of slots 48 must be the same as the spacing of the tabs 42 on the flanges 18 in order to correctly mate. But the spacing of slots 48 and corresponding tabs 42 on a first flange 18 may not be identical to the spacing of slots 48 and corresponding tabs on a second flange 18. In FIG. 15, the spacing of slots 48 and corresponding tabs 42 on a first flange 18 is shown by the letter “A.” The spacing of slots 48 and corresponding tabs 42 on a second flange 18 is shown by the letter “B.”

In theory the distance A could equal the distance B. Where characteristics of the first flange 18 are different than those on second flange 18 due to factors such as the requirements of attaching the respective flanges 18 to their corresponding slots 48 on trusses 14 or reflector panels 16, it is possible to inadvertently place the first flange 18 where the second flange 18 belongs and vice versa. Making the spacing A different from the spacing B means that the first flange 18 can only be mated with its corresponding slot 48 and the second flange 18 can only be mated with its corresponding slot 48. Thus, via the principle of Poka-yoke, this configuration prevents the incorrect placement of flanges 18. Said another way, this configuration, if applied to all or at least desired flanges 18, assures that only the desired flanges 18 can be mated with their respective slots 48.

As shown in FIGS. 15 and 16, flange 18 is mounted to a truss 14 through a slot 48. However, flanges 18 may also or in the alternative be connected to another truss 14 (FIG. 19) or a reflector panel 16 (FIG. 21). In these embodiments of the invention, it is preferred, but not required, that the mating geometry of the mounting flange 18 on either the second truss 14 or reflector panel 16, is unique (e.g., the spacing between tabs 42 as well as the corresponding spacing between slots 48 are unique to a specific flange 18 or group of flanges 18). As a result, coupling the flange 18 on a truss 14 to either a truss 14 or reflector panel 16 means that the correct flange 18 is used to ensure the desired configuration, position and orientation of the flange 18 to either the other truss 14 or reflector panel 16. In other words, having unique shapes for flanges 18 and their corresponding slots 48 prevents mating between such pairs in a position incompatible with a desired configuration, position or orientation.

As a further example of the application of the Poke-yoke principle, as shown in FIG. 17, the reflector panel 16 shown immediately above the truss 14 has its hardware 28 aligned with specific flanges 18 on the truss 14. This alignment occurs because of both the physical location of the respective flanges 18 with the hardware 28 on the reflector panel 16 and the orientation of flanges 18 with the hardware 28. This alignment allows truss 14 to be securely fastened to and correctly oriented with the desired reflector panel 16.

In the reflector panel 16 located farthest above the truss 14, the location of the flanges 18 on truss 14 do not correspond with all the locations of the hardware 28 on this reflector panel 16 so that this reflector panel 16 could not be effectively connected to the truss 14. This misalignment of flanges 18 and the hardware 28 here would be deemed “not fitting” and would alert the assembler that this particular reflector panel 16 would not be the correct piece to install at the location shown in FIG. 17. This prevents the incorrect installation of reflector panels 16 on trusses 14.

This unique geometry could be for example unique spacing for tabs 42 and corresponding slots 48 as described above. Alternately this unique geometry could be manifest in the dimensions of tabs 42 and slots 48. For example, tabs 42 and corresponding slots 48 could have unique angles between the mounting surfaces 40 and tabs 42 (e.g., one flange 18 has an angle between the mounting surface 58 and tabs 42 of 90 degrees whereas another flange 18 has an angle between its mounting surface 58 and tabs 42 of 80 degrees).

In a variant on this embodiment, the mating geometry of at least one mounting surface 58 is chiral so that it cannot be inserted into the correct slots on the wrong side of the truss 14. Being chiral means that the geometry of the element exhibits a directionality so that even though two elements may look similar, they are not identical. An example of chirality is your left and right hands. Left hands don't fit in right handed gloves and vice versa.

An example of chirality is that the length of a tab 42 (i.e., the distance from where the tab 42 connects to the mounting surface 58 to the farthest extremity of tab 42) is different for each of the two tabs 42. To mate with this flange 18, slots 48 would have to have corresponding lengths. A flange 18 also having two tabs 42 of the same length but with the lengths reversed could not be mated with the slots 48 made for its chiral flange 18.

Thus, having chirality assures that the parts, here specific flanges 18, match up with specific locations of slots 48 as desired. Thus, chirality is another way that the flanges 18 and corresponding slots 48 can be formed so that only desired elements can actually mate together. These features of the invention follow the concept of Poka-yoke to prevent parts from being assembled incorrectly and assures that there is only one possible way to assemble parts. This increases the speed of assembly and prevents costly errors (FIGS. 16 and 17).

In the majority of the examples of embodiments of the invention disclosed, the flanges 18 have been formed on at least one truss 14 and the corresponding slots 20 or 42 or hardware 28 formed or located on the reflector panels 16. This has been for ease of illustrating the invention and is not intended to limit the invention. Flanges 18 could be formed on reflector panels 16 with slots 20 or hardware 28 formed or located on at least one truss 14 and still be within the bounds of the invention.

The detailed description of various embodiments herein has made reference to the accompanying drawings, which show various embodiments by way of illustration. While these various embodiments are described in sufficient detail to enable those skilled in the art to practice the inventions, it should be understood that other embodiments maybe realized and that logical, chemical and mechanical changes may be made without departing from the spirit and scope of the inventions. Thus, the detailed description herein is presented for purposes of illustration only and not of limitation. For example, the features or other configuration descriptions may be used in any combination or configuration and are not necessarily limited to the configurations presented.

Furthermore, any reference to singular includes plural embodiments and any reference to more than one component or step may include a singular embodiment or step. Also, any reference to attached, fixed, connected or the like may include permanent, removable, temporary, partial, full, and/or any other possible attachment option. Additionally, any reference to without contact or similar phrases may also include reduced contact or minimal contact.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising“ includes embodiments that could be described as ”consisting essentially of“ or ”consisting of“, and as such the written description requirement for claiming one or more embodiments of the present invention using the phrase ”consisting essentially of” or “consisting of” is met.

Reference numbers recited herein, in the drawings, and in the claims are solely for ease of examination of this patent application and are exemplary. The reference numbers are not intended in any way to limit the scope of the claims to the particular features having the corresponding reference numbers in the drawings.

All these alternatives and variations are intended to be included within the scope of the attached claims. Those familiar with the art may recognize other equivalents to the specific embodiments described herein which equivalents are also intended to be encompassed by the claims attached hereto. As a result, while the above description contains many specificities, these should not be construed as limitations on the scope of the invention but rather as examples of different embodiments thereof.

The components, elements and characteristics of the description herein and corresponding reference numbers are:
Antenna system 2;
Dish structure 4;
Space frame 6;
Truss structure 8;
Node 10;
Support structure 12;
Truss 14;
Reflector panel 16;
Flange 18;
Slot 20;
Flat material 22;
Web 24;
Tube 26;
Hardware 28;
First plane 30;
First bending axis 32;
First bend angle 34;
Second plane 36;
Second bending axis 38;
Second bend angle 40;
Tab 42;
Folded edge 44;
Outer edge 46;
Mating slot 48;
Slit 50;
Edge 52 (of tab 42);
Hole 54;
Holes 56;
Mounting surface 58; and
Separate piece 60.

What is claimed is:

1. Support system elements in a support system for a radio reflector dish and the reflector dish itself, the radio dish having at least one reflector panel and the support system having at least one truss, the elements chosen from the group consisting of at least one reflector panel having a slot and the at least one truss having a corresponding flange and the at least one reflector panel having a flange and the at least one truss having a corresponding slot, whereby the reflector panel is placed into close contact with truss and the respective flange and slot mate to hold the reflector panel in a fixed position relative to the truss.

2. The support system of claim 1 wherein the truss is a unibody truss.

3. The support system of claim 1 wherein the truss is formed by a method chosen from the group consisting of bending, folding, pressing, stamping, welding, glueing or adhesives to form the shape of the truss.

4. The support system of claim 1 wherein the truss has a closed cross-sectional shape.

5. The support system of claim 1 wherein the first truss includes at least one folded edge to provide increased stiffness to the first truss.

6. The support system of claim 1 wherein the reflector panel includes at least one folded edge to provide increased stiffness to the reflector panel.

7. The support system of claim 1 wherein the flange and slot mate in a tab-and-slot locking joint.

8. The support system of claim 1 wherein
a. the flange is a first flange and slot is a first corresponding slot, the first flange and first slot having unique geometric dimensions that limits and establishes a relative position between the first flange and its corresponding first slot to a predetermined mating configuration based on the geometry of the first flange and first slot; and
b. the support system includes a second flange and a second slot, the second flange and second slot having unique geometric dimensions that limits and establishes a relative position between the second flange and its corresponding second slot to a predetermined mating configuration based on the geometry of the second flange and second slot;
c. whereby only the first flange and second slot can mate together and only the second flange and second slot can mate together;
d. whereby the position of reflector panels and trusses associated with the respective first flange and first slot are uniquely geometrically positioned and the position of the reflector panels and trusses associated with the respective second flange and second slot are uniquely positioned.

9. The support system of claim 1 wherein:
a. the reflector panel has at least two slots;
b. there are at least two trusses; and
c. each truss has at least one flange configured to mate with a corresponding slot on the reflector panel;
whereby the reflector panel is placed into close contact with each of the trusses so that the flange on each truss mates with a slot on the reflector panel to securely hold the reflector panel in a fixed position relative to the trusses.

10. The support system of claim 9 wherein at least two of the trusses are attached to each other to establish a fixed relationship between the trusses.

11. The support system of claim 10 wherein at least a first of the two trusses has a slot and a second of the two trusses has a flange so that the flange mates with the slot on the second truss to hold the two trusses in a fixed position relative to each other.

12. The support system of claim 1 wherein:
a. the reflector panel has at least two flanges;
b. there are at least two trusses; and
c. each truss has at least one slot configured to mate with a corresponding flange on the reflector panel;
whereby the reflector panel is placed into close contact with each of the trusses so that the slot on each truss mates with a flange on the reflector panel to securely hold the reflector panel in a fixed position relative to the trusses.

13. The support system of claim 12 wherein at least two of the trusses are attached to each other to establish a fixed relationship between the trusses.

14. The support system of claim 13 wherein at least a first of the two trusses has a slot and a second of the two trusses has a flange so that the flange mates with the slot on the second truss to hold the two trusses in a fixed position relative to each other.

15. The support system of claim 1 wherein the truss and reflector panel each have a flange and the flanges are connected by hardware.

16. The support system of claim 1 wherein the truss includes at least one hole cut in the truss whereby the hole functions to perform a benefit selected from the group consisting of decreasing the weight of the structure, decreasing the wind drag of the truss, providing access to other components and showing or creating a visual design.

17. Support system elements in a support system for a radio reflector dish and the reflector dish itself, the radio dish having at least one reflector panel having at least one folded edge to provide increased stiffness to the reflector panel and the support system having at least one truss formed from at least one sheet of flat material wherein the first truss includes at least one folded edge to provide increased stiffness to the first truss, the elements chosen from the group consisting of at least one reflector panel having a slot and the at least one truss having a corresponding flange and the at least one reflector panel having a flange and the at least one truss having a corresponding slot, whereby the reflector panel is placed into close contact with truss and the respective flange and slot mate in a tab-and-slot locking joint to hold the reflector panel in a fixed position relative to the truss.

18. The support system of claim 17 wherein
a. the flange is a first flange and slot is a first corresponding slot, the first flange and first slot having unique geometric dimensions that limits and establishes a relative position between the first flange and its corresponding first slot to a predetermined mating configuration based on the geometry of the first flange and first slot; and
b. the support system includes a second flange and a second slot, the second flange and second slot having unique geometric dimensions that limits and establishes a relative position between the second flange and its corresponding second slot to a predetermined mating configuration based on the geometry of the second flange and second slot;
c. whereby only the first flange and second slot can mate together and only the second flange and second slot can mate together;
d. whereby the position of reflector panels and trusses associated with the respective first flange and first slot are uniquely geometrically positioned and the position of the reflector panels and trusses associated with the respective second flange and second slot are uniquely positioned.

19. The support system of claim 17 wherein the truss includes at least one hole cut in the truss whereby the hole functions to perform a benefit selected from the group consisting of decreasing the weight of the structure, decreasing the wind drag of the truss, providing access to other components and showing or creating a visual design.

20. A method of connecting elements in a support system for a radio reflector dish and the reflector dish itself comprising the steps of:
a. providing at least one reflector panel;
b. providing at least one truss;
c. the elements chosen from the group consisting of at least one reflector panel having a slot and the at least one truss having a corresponding flange and the at least one reflector panel having a flange and the at least one truss having a corresponding slot;
d. placing the reflector panel into close contact with truss; and
e. mating the respective flange and slot to hold the reflector panel in a fixed position relative to the truss.
